(19) United States
(12) Patent Application Publication
(10) Pub. No.: US 2012/0209796 A1
(43) Pub. Date: Aug. 16, 2012

(54) ATTENTION FOCUSING MODEL FOR NEXTING BASED ON LEARNING AND REASONING

(75) Inventors: Akshay Vashist, Plainsboro, NJ (US); Shoshana Loeb, Philadelphia, PA (US)

(73) Assignee: TELCORDIA TECHNOLOGIES, INC., Piscataway, NJ (US)

(21) Appl. No.: 13/207,660

(22) Filed: Aug. 11, 2011

Related U.S. Application Data
(60) Provisional application No. 61/372,915, filed on Aug. 12, 2010.

(51) Int. Cl. G06F 15/18

(52) U.S. Cl. 706/12

(57) ABSTRACT

A system and method for nexting is presented. The method comprises computing an expected event, observing a new event, when the expected event matches the new event, processing the new event and performing action in accordance with given concepts, when the expected event does not match the new event and the new event can be explained based on the given concepts, processing the new event and performing action in accordance with the given concepts, and when the expected event does not match the new event and the new event cannot be explained based on the given concepts, employing learning mechanism and performing action decided on by the learning mechanism. In one aspect, the method comprises generating new concepts using reasoning or learning. In one aspect, the method comprises converting sensed numerical data into events of interest via the application of learned functions operating on the numerical data.

### CROSS REFERENCE TO RELATED APPLICATIONS

The present invention claims the benefit of U.S. provisional patent application 61/372,915 filed Aug. 12, 2010, the entire contents and disclosure of which are incorporated herein by reference as if fully set forth herein.

### FIELD OF THE INVENTION

This invention relates to artificial intelligence, machine learning, expectation guided information processing, and symbolic reasoning.

### BACKGROUND OF THE INVENTION

Arriving at timely decisions is critical to survival of biological systems and this necessitates limiting higher cognitive processing to relevant inputs. This functionality in biological systems is controlled by an attention focusing mechanism of directing attention through constructing expected future events. Arguably, this functionality is most developed in humans and it is said that “the greatest achievement of the human brain is the ability to imagine objects and episodes that do not exist in the realm of the real, and it is this ability that allows us to think about the future”. The human brain is an “anticipation machine”, and the function of predicting or “making future” is perceived as the most important thing the brain does. Motivated by this, mechanisms to incorporate some aspects of future expectation and surprise as a trigger for learning have been incorporated in artificial intelligence (AI) and Robotics.

There are at least two ways in which brains might be said to anticipate the future. The first, which is shared across higher animals, allows a seamless and uninterrupted processing of information streams by the brain. It entails the prediction of the immediate next event or signal that the brain expects to see based on inputs from the present and the immediate past. This mechanism of creating and expecting the future remains unnoticed until it fails, in which case we are surprised, e.g., finding a tiger in a city street. This way of anticipating or making the future is denoted as “nexting”—immediate prediction or anticipation. The second way of anticipating the future is unique to humans and involves the ability to imagine an experience without any direct stream of information from the environment, e.g., imagining a reaction to seeing a tiger in the street.

In computational systems, expectation based prediction is symbolic and so is reasoning. However, known nexting solutions do not use both learning and reasoning to predict the immediate next event or action. Instead, researchers have adopt one approach or the other, so that a hybrid solution is needed to computationally realize nexting.

### SUMMARY OF THE INVENTION

Current solutions for the focusing of attention problem do not use expectation based processing and symbolic reasoning to filter out “routine” information before employing statistical machine learning. The present invention provides a method and a system for increasing the effectiveness of machine learning and provides a human friendlier way to understand the system operations as compared with a purely statistical system. Cognitive processes that enable nexting in biological systems are assumed, as is a cognitive architecture base.

The inventive solution solves the problem of real time processing of events in a way that effectively utilizes prior knowledge about the situation to guide immediate next action and, at the same time, uses reasoning and statistical machine learning to handle situations that deviate from the expectations so that they are better handled in the future. Machine learning algorithms provide powerful solutions to the classification of information items for the purpose of predicting future behaviors. Symbolic reasoning systems are good at using information that has been already learnt. The novel system and method uses the best of both worlds to accomplish performance and usability, by using the best of machine learning and symbolic reasoning to accomplish greater performance, flexibility and usability.

The inventive system comprises a processor and a module operable to compute an expected event, observe a new event, when the expected event matches the new event, process the new event and perform action in accordance with given concepts, when the expected event does not match the new event and the new event can be explained based on the given concepts, process the new event and perform action in accordance with the given concepts, and when the expected event does not match the new event and the new event cannot be explained based on the given concepts, employ learning mechanism and perform action decided on by the learning mechanism. In one aspect, the module is further operable to generate new concepts using reasoning or learning. In one aspect, the module is further operable to convert the new event to numerical data and then convert the numerical data to newer events, for example, as done by sensors sensing information from the real world and then a learned function mapping them to predefined events.

The inventive method comprises computing an expected event, observing a new event, when the expected event matches the new event, processing, using a processor, the new event and performing action in accordance with given concepts, when the expected event does not match the new event and the new event can be explained based on the given concepts, processing the new event and performing action in accordance with the given concepts, and when the expected event does not match the new event and the new event cannot be explained based on the given concepts, employing learning mechanism and performing action decided on by the learning mechanism. In one aspect, the method further comprises generating new concepts using reasoning or learning. In one aspect, the method further comprises converting the new event to numerical data and then converting the numerical data to newer events as described above.

A computer readable storage medium storing a program of instructions executable by a machine to perform one or more methods described herein also may be provided.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 shows information flows in the inventive system.

FIG. 2 illustrates a generic learning scenario.

FIG. 3 illustrates the high level architecture of the inventive system.

FIG. 4 is a flow diagram of the inventive method.

### DETAILED DISCLOSURE

There exists a vast body of work that has studied as well as modeled the mechanism of nexting—the automated near-term, localized anticipation of events. In particular, “surprise” or expectation failure based mechanisms have been utilized to focus the learning mechanism. This has been accomplished in several ways, ranging from relying on generalized relationships between concepts in the knowledge domain to utilizing specific knowledge of experienced and concrete problem situations. For example, the generalized knowledge could be structured in knowledge organization units such as scripts, frames, maps or schemas. Alternatively, the specific experiential information can be structured as cases. In both approaches, the knowledge, whether general or specific, is used as a source for the processing of the input stream by generating the expectation for the next item and comparing it to the actual input. This comparison or matching does not necessarily have to be exact and, more importantly, it helps with the processing of incomplete or ambiguous information.

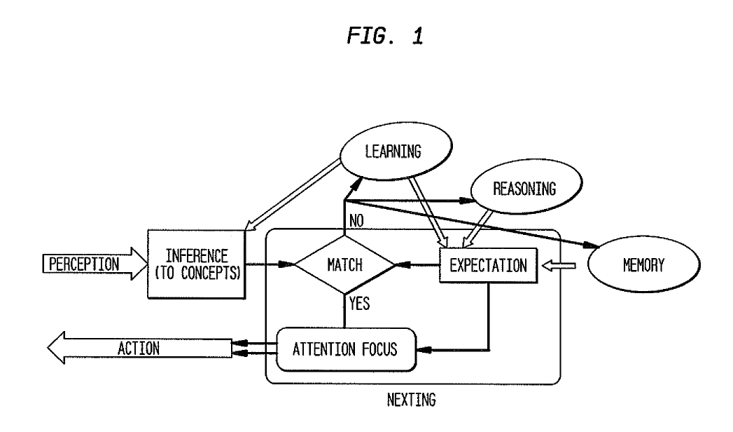

FIG. 1 illustrates logical architecture describing functional relationships between components involved in nexting. As shown in FIG. 1, perception and learning both relate to inference (to concepts). Learning also relates to expectation, as does reasoning and memory. Expectation, matching and attention focus are portions of nexting, from which actions can be produced.

Accordingly, as shown in FIG. 1, nexting emerges from an interaction between learning, reasoning, inference, memory, expectation, and attention focus mechanisms. It closely interacts with expectation generation and expectation matching. When conceptual representations of perceptual inputs (from multiple sources) match or nearly match the expectation, nexting continues in a default mode where it can be thought of as inference based on prior learning. When perceptual input does not match with expectation or cannot be transformed into known concepts, reasoning is invoked to reconcile the current input with the recent historical inputs. If a consistent reconciliation is found, new expectation is modified; otherwise, the conceptual anomaly is recorded in memory and when enough of such anomalies accumulate, learning attempts to generalize them to modify existing concepts or to develop new concepts. The modifications or the new concepts are then updated as new inference rules and also act as knowledge base for reasoning.

The process of nexting is seamless, fast and coherent. Unless interrupted by a failed prediction or unmet expectation, the nexting process proceeds without surprises in interpreting a stream of information. Nexting shares some of its functionality with automated planning and scheduling which is a deliberate visualization of future scenarios and has been widely studied in AI. The overlap and differences between nexting and automated planning are primarily in the time scale of action and amount of computation. Planning is usually defined as finding a sequence of actions from a given set of actions which is often formulated as a computationally expensive offline process. On the other hand, nexting is an online process which is guided by both attention focus and expectation of future external inputs or imagination, and is therefore not entirely goal driven as is the case with planning. Informally, planning is more associated with scheduling whereas nexting is associated with execution control. Moreover, planning is in response to a particular goal but nexting always follows the same attention focus mechanism.

Nexting can be viewed as a manifestation of interaction between learning, reasoning, memory and attention focus mechanisms. Furthermore, nexting can be seen as being controlled by the attention focus mechanism that can operate in two different modes: future imagination and execution control for actions in the real world. In either case, it is an inference process.

Nexting is a form of an inference process and is based on either knowledge which is gathered from learning from past experience or from knowledge which is generated from reasoning about the current situation. The dichotomy between the two modes is demonstrated during the processing of information and expectation failure. When expectations are met, the inference is likely to be based on learning (conditioning) based on past experience which is usually a fast process. When expectations fail, the system is guided by reasoning on gathered knowledge which is usually a slower process. Furthermore, the information gathered from the nexting and expectation failure can also trigger learning of new concepts. This usually happens when a critical number of cases of expectation failures accumulate to enable generalization into new patterns or concepts.

As discussed above, nexting is realized by the attention focus module. Depending on the situation, nexting can be argued as predicting the immediate action based on past experience (learning) or reasoning on the active knowledge. The learning and reasoning modules shape the formation of inference in nexting and, in a role reversal, the inputs to modify learning and reasoning are obtained from the attention focus module via nexting. In other words, whenever an expectation mismatch or a surprise occurs, the cases are reasoned either as special instances of existing concepts or determined as instances of potential new concepts and become inputs to the learning new concepts.

Note that learning and reasoning are themselves interconnected concepts. They can be distinguished based on the direction of processing inputs and the speed of inference. Inference based on learning usually processes inputs in a single direction to derive the conclusion whereas reasoning processes inputs and knowledge in multiple passes back and forth to reach a conclusion. Thus inference based on learning is faster and is dominant in processing perceptual inputs while reasoning is dominant in higher level “sensemaking” processes.

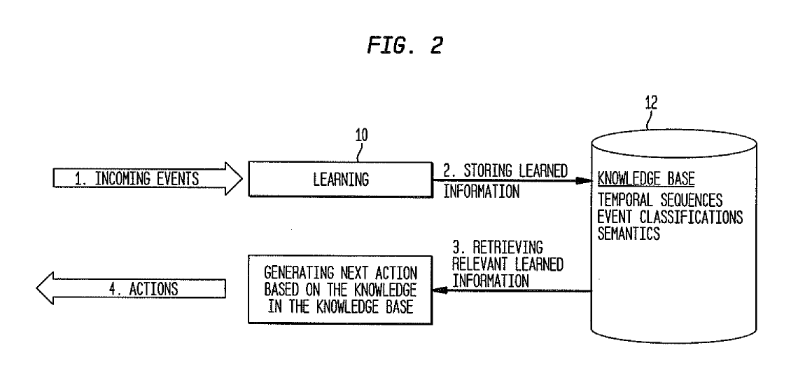

FIG. 2 depicts the generic scenario in which an information stream represented as “incoming events” is flowing into a system which includes a learning mechanism. FIG. 2 shows (1) incoming events as input to Learning 10. Learning outputs (2) learned information which is stored in a Knowledge Base 12. This learned information can be in the form of temporal sequences, event classifications, semantics, or other appropriate formats. The next action can be generated based on (3) relevant learned information retrieved from the Knowledge Base. Actions (4) can be created from the generated next action.

The learning mechanism may transform the input representation of the incoming event into a numerical vector representation and then compare it to what was seen before applying a learnt function. The learnt function can be very versatile and, depending on the task, may involve classifying information, predicting new values (regression), ranking events and/or information, etc.

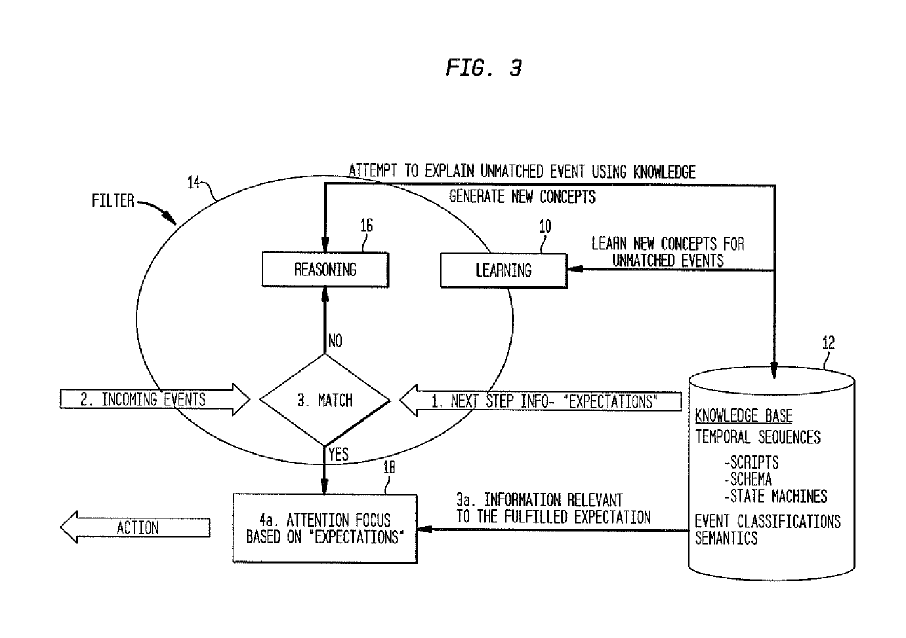

FIG. 3 depicts the high level architecture of the inventive system. The inventive system uses prior knowledge in a symbolic form to focus and guide the learning mechanism. The collection of processes that use symbolic knowledge are denoted as a symbolic “filter” 14. The system also contains Learning 10, Reasoning 16 and Knowledge Base 12.

At the heart of the symbolic filter 14 is the mechanism of “nexting” which consists of providing the system with “expectation” about what event is likely to flow in, or occur, next based on the context and prior events as well as stored knowledge about the general type of situation and specific knowledge about the current situation. Nexting is a theoretical construct that can be realized using our invention.

To be precise, nexting is a form of an inference process and is based on either knowledge which is gathered from learning from past experience or from knowledge which is generated from reasoning about the current situation. The dichotomy between the two modes is demonstrated during the processing of information and expectation failure. When expectations are met, the inference is likely to be based on learning (conditioning) based on past experience which is usually a fast process. When expectations fail, the system is guided by reasoning on gathered knowledge which is usually a slower process. Furthermore, the information gathered from the nexting and expectation failure can also trigger learning of new concepts. This usually happens when a critical number of cases of expectation failures accumulate to enable generalization into new patterns or concepts.

As discussed above, nexting is realized by the attention focus module 18. Depending on the situation, nexting can be argued as predicting the immediate action based on past experience (learning) or reasoning on the active knowledge.

The learning 10 and reasoning 16 modules shape the formation of inference in nexting and, in a role reversal, the inputs to modify learning and reasoning are obtained from the attention focus module 18 via nexting. In other words, whenever an expectation mismatch or a surprise occurs, the cases are reasoned either as special instances of existing concepts or determined as instances of potential new concepts and become inputs to the learning of the new concepts.

FIG. 3 illustrates the following processing steps, indicated as arrows. Step 1: Expectation is set for the next event, e.g., expected event, based on the current state/observation. Step 2: A new event is observed. Step 3: The system determines whether or not the new event matches the expected event.

Step 3a: If the expectations are met, the system carries out its normal functioning, bringing out relevant information from the knowledge base, to process the event. Step 4a: Using the information about the current event in the context of past events, the system decides on an action (if any).

Step 3b: If the expectation is not met, the system tries to explain the discrepancy based on its knowledge. If successful, the explanation is stored in the knowledge base and steps 3a and 4a are carried out. Step 4b: If reasoning failed to produce an explanation for the discrepancy, the learning mechanism is employed after the data is converted to a numeric form.

The learning mechanism then considers the cases in which reasoning has been set aside to be analyzed later. Once the reasoning system organizes these cases into new categories or provides any other structure, the learning mechanism learns to transform the events and/or information to those new categories or structures. Thus, reasoning generates new concepts, and later, learning mechanism adapts the system to directly transform similar events and/or information to new concepts without having to reason about them to facilitate real-time processing and action relevant to those events.

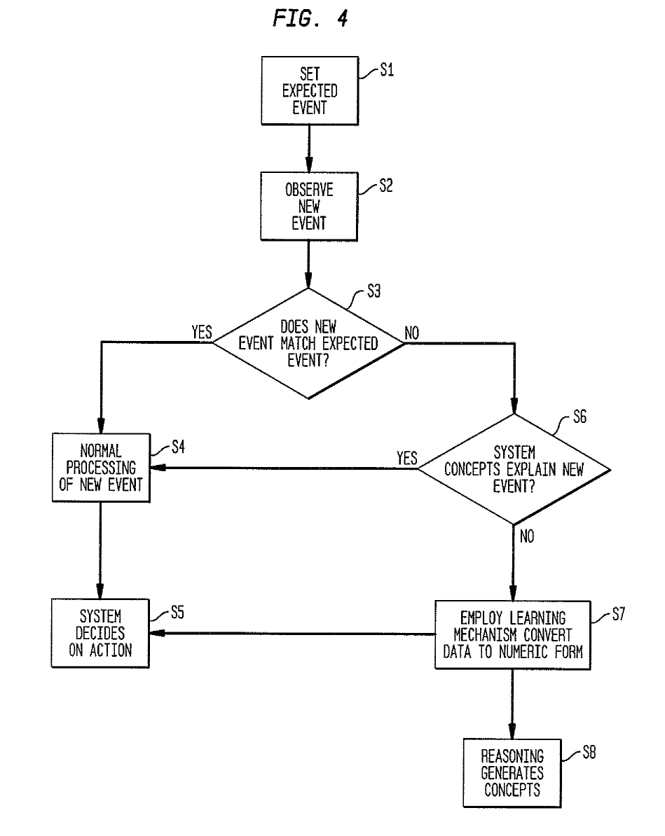

FIG. 4 is a flow diagram of the inventive method. In step S1, an expected event is set. In step S2, a new event is observed. In step S3, the new event is compared to the expected event. If the new event matches the expected event (S3=YES), then, in step S4, normal processing of the new event occurs, and, in step S5, the system decides on the appropriate action, for example by using known concepts.

Otherwise, if the new event does not match the expected event (S3=NO), then an explanation of the new event is sought. If the system can explain the new event (S6=YES), then the new event is processed using normal processing, that is, processing continues at step S4.

Otherwise, if the system cannot explain the new event (S6=NO), then a learning mechanism is employed in step S7. Based on the learning mechanism, processing can continue at step S5 and/or reasoning can receive the new event and generate concepts in step S8.

In one embodiment, the novel method can be performed on a processor, such as a CPU or other device.

The invention can be used as part of an information processing software system that monitors activities in a noisy, mission critical environment. The system not only can effectively detect routine activity but can also detect and learn meaningful deviations from the routine for the purpose of anomaly detection and adaptation.

Various aspects of the present disclosure may be embodied as a program, software, or computer instructions embodied or stored in a computer or machine usable or readable medium, which causes the computer or machine to perform the steps of the method when executed on the computer, processor, and/or machine. A program storage device readable by a machine, e.g., a computer readable medium, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc. The system also may be implemented on a virtual computer system, colloquially known as a cloud.

The computer readable medium could be a computer readable storage medium or a computer readable signal medium. Regarding a computer readable storage medium, it may be, for example, a magnetic, optical, electronic, electromagnetic, infrared, or semiconductor system, apparatus, or device, or any suitable combination of the foregoing; however, the computer readable storage medium is not limited to these examples. Additional particular examples of the computer readable storage medium can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an electrical connection having one or more wires, an optical fiber, an optical storage device, or any appropriate combination of the foregoing; however, the computer readable storage medium is also not limited to these examples. Any tangible medium that can contain, or store a program for use by or in connection with an instruction execution system, apparatus, or device could be a computer readable storage medium.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server, and network of servers (cloud). A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

What is claimed is:

1. A method for nexting, comprising steps of:
computing an expected event;
observing a new event;
when the expected event matches the new event, processing, using a processor, the new event and performing action in accordance with given concepts;
when the expected event does not match the new event and the new event can be explained based on the given concepts, processing the new event and performing action in accordance with the given concepts; and
when the expected event does not match the new event and the new event cannot be explained based on the given concepts, employing learning mechanism and performing action decided on by the learning mechanism.

2. The method according to claim 1, further comprising a step of generating new concepts using one of reasoning and learning.

3. The method according to claim 1, the step of employing the learning mechanism further comprising converting the new event to numerical data.

4. The method according to claim 3, further comprising:
converting the numerical data to newer event using sensors sensing information from the real world; and
mapping, using a learned function, the newer event to predefined events.

5. A system for nexting, comprising:
a processor;
a module operable to set an expected event, observe a new event, and when the expected event does not match the new event and the new event can be explained based on the given concepts, the module operable to process the new event and perform action in accordance with the given concepts, and when the expected event does not match the new event and the new event cannot be explained based on the given concepts, the module operable to employ learning mechanism and perform action decided on by the learning mechanism.

6. The system according to claim 5, the module further operable to generate new concepts using one of reasoning and learning.

7. The system according to claim 5, the module further operable to convert the new event to numerical data.

8. The system according to claim 5, the module further operable to convert the numerical data to newer event using sensors sensing information from the real world and to map, using a learned function, the newer event to predefined events.

9. A computer readable storage medium storing a program of instructions executable by a machine to perform a method for nexting, comprising:
setting an expected event;
observing a new event;
when the expected event matches the new event, processing, using a processor, the new event and performing action in accordance with given concepts;
when the expected event does not match the new event and the new event can be explained based on the given concepts, processing the new event and performing action in accordance with the given concepts; and
when the expected event does not match the new event and the new event cannot be explained based on the given concepts, employing learning mechanism and performing action decided on by the learning mechanism.

10. The computer readable storage medium according to claim 9, further comprising generating new concepts using one of reasoning and learning.

11. The computer readable storage medium according to claim 9, further comprising converting the new event to numerical data.

12. The computer readable storage medium according to claim 9, further comprising:
converting the numerical data to newer event using sensors sensing information from the real world; and
mapping, using a learned function, the newer event to predefined events.
